(19) United States
(12) Patent Application Publication
(10) Pub. No.: US 2024/0211983 A1
(43) Pub. Date: Jun. 27, 2024

(54) WIRELESS IDENTIFIER DEVICE ENABLED INTERACTIVE CONSUMER EXPERIENCE

(71) Applicant: Transform SR Brands LLC, Hoffman Estates, IL (US)

(72) Inventors: Smita Katakwar, Schaumburg, IL (US); Siddharth Deshmukh, Chicago, IL (US)

(21) Appl. No.: 18/233,104

(22) Filed: Aug. 11, 2023

Related U.S. Application Data
(63) Continuation of application No. 14/075,121, filed on Nov. 8, 2013, now abandoned.

(51) Int. Cl. G06Q 30/0207

(52) U.S. Cl. CPC G06Q 30/0207

(57) ABSTRACT

A system and method supporting user engagement in consumer activities at one or more locations of a merchant.

### FIELD OF THE INVENTION

Certain embodiments of the present invention relate to systems and methods for providing product information to consumers. More specifically, certain aspects of the present invention relate to a system and/or method that promotes a consumer shopping experience with increased consumer engagement through the use of a user device and various forms of wireless identification devices and a supporting merchant system.

### BACKGROUND OF THE INVENTION

Electronic shelf labels (ESLs) are used to display limited information such as product identifiers, details, and pricing information typically transmitted to the ESLs using a wireless infrastructure. ESLs have been developed that have an embedded near-field-communication (NFC) or radio frequency identification (RFID) device that permits wireless identification of the item with which the ESL is associated by a user device such as an NFC or RFID enabled smart phone or special purpose merchant device. The use of various forms of product tracking devices such as RFID tags and loss/theft control device is known.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method that promotes a consumer shopping experience with increased consumer engagement, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is an illustration of exemplary computer network in which a representative embodiment of the present invention may be practiced.

FIG. 2 shows a block diagram of an exemplary system that supports a consumer shopping experience with increased consumer engagement through the use of a merchant system, a user device, and various forms of wireless identifier devices, in accordance with a representative embodiment of the present invention.

FIG. 3 illustrates exemplary social networking aspects of a system such as that shown in FIG. 2, in accordance with a representative embodiment of the present invention.

FIGS. 4A-4C illustrate a flowchart showing an exemplary method of operating a user device and various forms of wireless product identification devices in an in-store consumer activity, in accordance with a representative embodiment of the present invention.

FIGS. 5A-5B illustrate a flowchart showing an exemplary method of operating a system that supports in-store consumer activities with a user device such as, for example, the host system of FIG. 1 communicating with a mobile application in a user device that may correspond to, for example, the user device of FIG. 1 of user device of FIG. 6, wherein the mobile application operates as described with respect to the method of FIGS. 4A-4C, in accordance with a representative embodiment of the present invention.

FIG. 6 is a block diagram illustrating a personal electronic device that may correspond to, for example, the electronic devices shown in FIG. 1, in accordance with a representative embodiment of the present invention.

### DETAILED DESCRIPTION OF THE INVENTION

Aspects of the present invention relate to systems and methods for providing product information to consumers. More specifically, certain aspects of the present invention relate to a system and/or method that promotes a consumer shopping experience with increased consumer engagement through the use of a user device, various forms of wireless identification devices, and a supporting merchant system.

The following description of example methods and apparatus is not intended to limit the scope of the description to the precise form or forms detailed herein. Instead the following description is intended to be illustrative so that others may follow its teachings.

The present application makes reference to U.S. patent application Ser. No. 13/494,758, entitled “Systems and Methods for High-Precision In-Store Positioning, Navigation and Shopping Behavior Profiling,” filed Jun. 12, 2012, the complete subject matter of which is hereby incorporated herein by reference, in its entirety.

In the following discussion, the terms “customer service agent” and “sales associate” may be used herein interchangeably to refer to an employee or other individual who provides product and/or sales related assistance to customers of a business. The sales associate or customer service agent may be, by way of example and not limitation, an expert, question and answer provider, merchandise associate, etc. The terms “customer,” “consumer,” and “user” may be used herein interchangeably to refer to a potential or existing purchaser of products and/or services of a business.

The term “social network” may be used herein to refer to a network of family, friends, colleagues, and other personal contacts, or to an online community of such individuals who use a website or other technologies to communicate with each other, share information, resources, etc.

As utilized herein, the terms “exemplary” or “example” means serving as a non-limiting example, instance, or illustration. As utilized herein, the term “e.g.” introduces a list of one or more non-limiting examples, instances, or illustrations.

The disclosed methods and systems may be part of an overall shopping experience system created to enhance the consumer shopping event. In one example, the disclosed system may be integrated with the customer's reward system, the customer's social network (e.g., the customer can post their shopping activity conducted through the system to their social network), the customer's expert system, digital/mobile applications, shopping history, wish list, location, merchandise selections, or the like. However, the system disclosed may be fully and/or partially integrated with any suitable shopping system as desired, including those not mentioned and/or later designed.

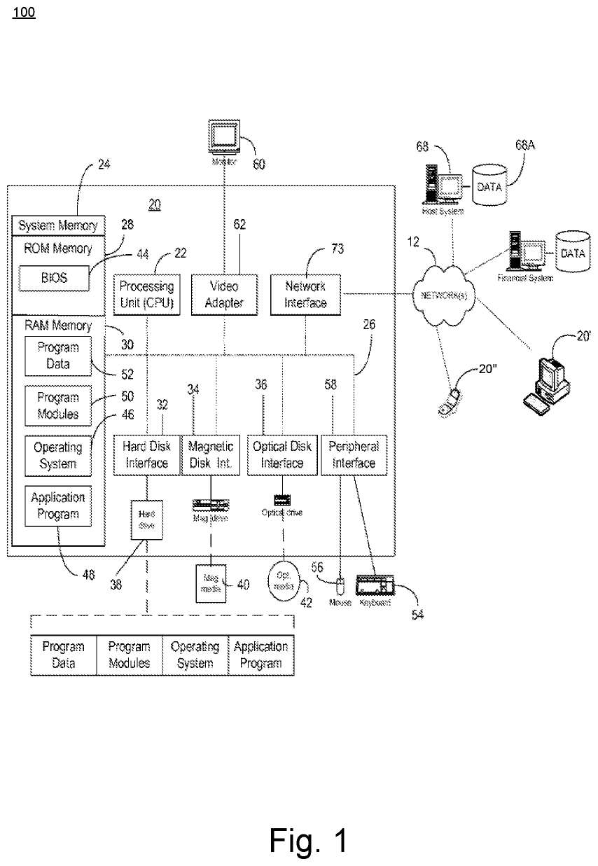

FIG. 1 is an illustration of exemplary computer network in which a representative embodiment of the present invention may be practiced. The following discloses various example systems and methods for, by way of example and not limitation, producing and delivering information to customers via a computer network, to a handheld or mobile device such as those described herein, and to other suitable devices such as kiosks and public terminals located both indoors and outdoors at merchant business and other locations. Referring now to FIG. 1, a processing device 20″, illustrated in the exemplary form of a mobile communication device, a processing device 20′, illustrated in the exemplary form of a computer system, and a processing device 20 illustrated in schematic form, are shown. Each of these devices 20, 20′, 20″ are provided with executable instructions to, for example, provide a means for a customer, e.g., a user, a customer or consumer, etc., or a sales associate, a customer service agent, and/or others to access a host system 68 and, among other things, enable user participation in consumer activities of a merchant, connect to a content management system or an electronic publication system of the merchant, enable access to a hosted social networking site, provide access to personal information of a user in a user profile maintained by the system, enable access to a store directory, and/or a sales associate. Generally, the computer executable instructions reside in program modules which may include routines, programs, objects, components, data structures, etc. that perform particular tasks or implement particular abstract data types. Accordingly, the processing devices 20, 20′, 20″ illustrated in FIG. 1 may be embodied in any device having the ability to execute instructions such as, by way of example, a personal computer, mainframe computer, personal-digital assistant (“PDA”), cellular telephone, tablet, e-reader, smart phone, or the like. Furthermore, while described and illustrated in the context of a single processing device 20, 20′, 20″, the various tasks described hereinafter may be practiced in a distributed environment having multiple processing devices linked via a local or wide-area network whereby the executable instructions may be associated with and/or executed by one or more of multiple processing devices.

For performing the various tasks in accordance with the executable instructions, the example processing device 20 includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer-readable instructions, data structures, program modules and other data for the processing device 20. Other types of non-transitory computer-readable media that can store data and/or instructions may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example via a network connection.

To allow a user to enter commands and information into the processing device 20, input devices such as a keyboard 54 and/or a pointing device 56 are provided. While not illustrated, other input devices may include a microphone, a joystick, a game pad, a scanner, a camera, touchpad, touch screen, etc. These and other input devices are typically connected to the processing unit 22 by means of an interface 58 which, in turn, is coupled to the bus 26. Input devices may be connected to the processor 22 using interfaces such as, for example, a parallel port, game port, FireWire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as, for example, speakers, cameras, printers, or other suitable device.

As noted, the processing device 20 may also utilize logical connections to one or more remote processing devices, such as the host system 68 having associated data repository 68A. In this regard, while the host system 68 has been illustrated in the exemplary form of a computer, the host system 68 may, like processing device 20, be any type of device having processing capabilities. Again, the host system 68 need not be implemented as a single device but may be implemented in a manner such that the tasks performed by the host system 68 are distributed amongst a plurality of processing devices/databases located at different geographical locations and linked through a communication network. Additionally, the host system 68 may have logical connections to other third party systems via a network 12, such as, for example, the Internet, LAN, MAN, WAN, cellular network, cloud network, enterprise network, virtual private network, wired and/or wireless network, or other suitable network, and via such connections, will be associated with data repositories that are associated with such other third party systems. Such third party systems may include, without limitation, systems of banking, credit, or other financial institutions, systems of third party providers of goods and/or services, systems of shipping/delivery companies, media content providers, document storage systems, etc.

For performing tasks as needed, the host system 68 may include many or all of the elements described above relative to the processing device 20. In addition, the host system 68 would generally include executable instructions for, among other things, supporting consumer activities accessible to users, storing personal information of users, storing merchant information about consumer shopping and purchase activities, coordinating storage and retrieval of various documents and information, social network storage of a shopping list, receiving a location of a customer via a mobile device, maintaining maps and layouts of buildings and geographic areas, calculating directions or routes within buildings and geographic areas, receiving a request for a service call center connection from either a customer or a sales associate, routing the request via a distributed mobile video call center, and providing a service call infrastructure for providing the requestor with a distributed customer service experience.

Communications between the processing device 20 and the host system 68 may be exchanged via a further processing device, such as a network router (not shown), that is responsible for network routing. Communications with the network router may be performed via a network interface component 73. Thus, within such a networked environment, e.g., the Internet, World Wide Web, LAN, cloud, or other like type of wired or wireless network, program modules depicted relative to the processing device 20, or portions thereof, may be stored in the non-transitory computer-readable memory storage device(s) of the host system 68 and processing devices 20, 20′ and 20″.

A representative embodiment of the present invention may be seen in a system and/or method that promotes a consumer shopping experience with increased consumer engagement through the use of a user device and various forms of wireless product identification devices supported by a merchant system, examples of which will be further described below.

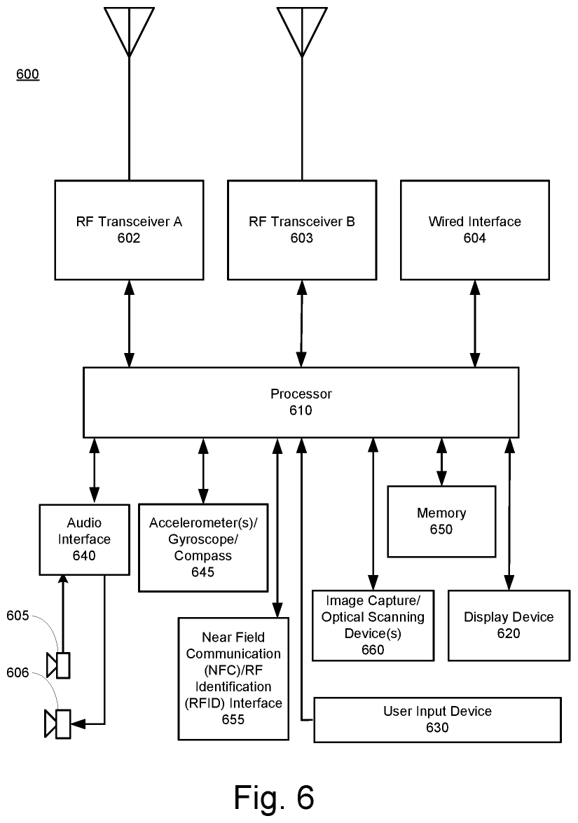

A representative embodiment of the present invention may engage a consumer in various in-store activities that may, for example, involve the use, by the consumer, of a software application or “app” on a mobile user device such as, for example, a cell phone, a smart phone, a media player, a handheld or tablet computer, or any other suitable electronic device. Such a user device may, for example, belong to the consumer, or may be loaned to the consumer by a merchant, as part of the consumer shopping activity in the store. FIG. 6 shows a block diagram illustrating the functional elements of an electronic device that may be suitable for use in an embodiment of the present invention, which will be described in greater detail later in this application.

In one representative embodiment of the present invention, the user may participate in an interactive in-store consumer activity such as, by way of illustration and not limitation, various forms of a game. Such a game may, for example, involve participants in a search for a series of clues, in which the search ultimately results in the participant be awarded something of value or receiving a value offer including, but not limited to, “points” or credits of a membership or loyalty program, free products or services, and percentage or cash discounts on products or services. Such awarded points or credits may be redeemable towards the purchase of products and/or services of the merchant or at a business partner of the merchant.

The participant in the activity may use a particular motion or gesture such as, for example, a “bump” or “tap” of the user device upon a product item, shelf label, hanger, display, in-store signage, or other object, when holding the user device in a certain orientation, to signal to the user device that the user wishes to capture the identifying information for the product and/or service, physical object, or location within the store.

The “bump” or “tap” may be sensed by the user device used by the consumer, and may cause the user device to capture information that identifies a particular product and/or service, a physical object, or a location within the store, within a certain capture range of the user device. The “bump” or “tap” gesture may, for example, be detected by components of the user device such as, by way of example and not limitation, one or more accelerometers, gyroscopes, or other suitable device(s).

A product and/or service, or a physical object or location within the store may be identifiable by a nearby electronic device using, by way of example and not limitation, radio frequency, electromagnetic, or visible or non-visible light (e.g., infrared) signals emitted or reflected by printed indicia or electronic display circuitry attached to or embedded within an object or product, a tag attached to an object or product, and/or a shelf label or hanger identifying an object or product. A product and/or service, a physical object, or a location within the store may also be identified using, by way of example and not limitation, a coded graphic such as a barcode, a two-dimensional (2D) code, a QR® code, or any other suitable indicia, using an image capture device or optical scanner contained within or attached to the user device used by a consumer. In some representative embodiment of the present invention, the identifying information may be unique to a particular instance of a product and/or service, a particular physical object, or a location within the store. In other representative embodiments, the identifying information may be common to all instances of that type of product and/or service, a type of physical object, or similar locations within a merchant location (e.g., a checkout counter, an elevator, an escalator). In addition, in some representative embodiments of the present invention, the coded graphic or other suitable indicia may be displayed using a dynamically electrically alterable display such as on LED, LCD, or what may be referred to herein as “electronic paper,” to enable a device such as an ESL to display a linear or 2D code such as, by way of example and not limitation, a UPC, barcode, QR Code®, or other suitable coding arrangement for optical scanning by a user device having an optical interface such as the user device of FIG. 6, discussed in further detail below.

In such an example embodiment, a member may be at or enter the business location of a merchant, and may have a mobile application or “app” for the merchant on a handheld electronic device such as, for example, a cell phone, a smart phone, a media player, a handheld personal computer (PC), a tablet computer, or other suitable user device. In one representative embodiment of the present invention, the user may select/activate the mobile application for the merchant, and may choose to participate in, for example, the day's “Treasure hunt” activity. In response to the user choosing the “Treasure Hunt” activity, the mobile app on the mobile device of the participant may then provide one or more clues on in text, graphics, or video playback on a display and/or may use audio playback, where the clues point the participant towards, for example, a particular product and/or service, a particular department, a particular sales associate, or a particular physical object or location within the store. The participant then attempts to determine, which product and/or service, sales associate, or physical object or location within the store is the target of the clue. The participant then moves to the location within the store to which they believe the product and/or service, the department, the sales associate, or the particular physical object or the location the clue directed them.

When the participant arrives at the location of the product and/or service, department, sales associate, or physical object or location within the store to which they believe the clue has directed them, the participant may, for example, :bump” or “tap” the product, a sign identifying the department, scan a tag attached to the product, and/or move the user device with a certain distance from a shelf label identifying the product, to capture information identifying the product and/or service, the department, the particular physical object, or the location within the store that they chose using the clue(s). In representative embodiments in which coded indicia are used, the participant may scan or capture the coded graphic (e.g., a barcode, a two-dimensional (2D) code, a QR® code, or any other indicia) using an image capture device or optical scanner contained within or attached to the mobile electronic device used by the participant.

If the participant has identified the correct product and/or service, sales associate, or physical object or location within the store, the mobile application may then play back a video describing the product, or information about the department in which the product is located.

If the participant has identified the wrong product and/or service, sales associate, or physical object or location within the store, the mobile application may then inform the participant that they're off track, and may repeat the current clue or instructions to the user, or provide an additional clue/hint at where the correct product and/or service, sales associate, or physical object or location can be found within the store.

If the participant successfully completes all of portions of the activity, in this example, the searches using the provided clues, the participant may then be awarded something of value such as, by way of example and not limitation, a certain number of “points” of a merchant loyalty program, a free product, and/or a value offer such as a percentage discount or cash value discount off of items purchased from the merchant, or any other suitable award.

However, if the participant has not yet found a target of a clue of the “Treasure Hunt” activity, the participant may be provided with another next clue, pointing the participant towards the next product and/or service, department, sales associate, or physical object or location within the store.

In some representative embodiments of the present invention, the clues provided to each participant may be selected so that the product(s) to which each clue points is of specific interest to the participant, based upon personal information of the user that is collected and maintained by the merchant. In some representative embodiments of the present invention, the path leading the participant to the product pointed to by a clue may be selected so that the participant in the activity will pass by the locations in the merchant location of products and/or services of specific interest to the participant. The selections of products and/or services, departments, sales associates, physical objects, and/or building features to which the clues are directed may be based on any of a number of factors. For example, in a representative embodiment of the present invention, the clues may be directed at products, services, and/or departments in which the participant has shown specific interest, by their purchase or shopping history or their search behavior, which the participant has explicitly self-identified specific interest or preference, or which have been determined to be of interest to others having similar demographics. Some possible sources of information about participant interests and preferences may be found in data repositories containing, by way of example and not limitation, participant purchase and shopping history information, participant product and/or service search activities at the web site of the merchant or performed using the mobile application on the mobile electronic device, and the results of prior Internet search activities on other devices such as, for example, a desktop PC, a laptop PC, or other electronic device used by the participant to access a web site associated with the merchant. In addition, information about consumer interests and preferences gathered through self-identification by the consumer for membership in a loyalty program of the merchant may also be used. Such self-identification may be through a web site or via the mobile application present on the mobile electronic device of the user.

In some representative embodiments of the present invention, the product and/or service targeted by a clue may be selected by a merchant system to directly broaden the consumer's experience with the products and product categories offered by the merchant, because the selected product is from a product category in which the consumer has seldom or never purchased goods or services from the merchant. By creating clues that require passage through areas of a merchant location displaying products not previously purchased, searched, or shopped, a representative embodiment of the present invention may raise the awareness of the user of the merchant as a source of such products or in such a category of products.

In a representative embodiment of the present invention, consumers may be limited to participation in a maximum number of activities in a particular time period. For example, a given consumer may be limited to participate in a certain maximum number of activities per store visit, or per day, or per month, or during a certain promotion period.

In some representative embodiments of the present invention, a participant may choose to end their participation before successfully completing the activity. In some of those embodiments, the participant that stops before successfully solving all clues may lose the ability to participate further in the consumer activity. In other embodiments, the participant may choose to leave the game at any given point, but may be awarded points only on successful completion of the “treasure hunt.”

It should be noted that in a representative embodiment of the present invention, aspects of each activity may be customized to the specific participant, based upon personal information collected and maintained by a system operated by or for a merchant.

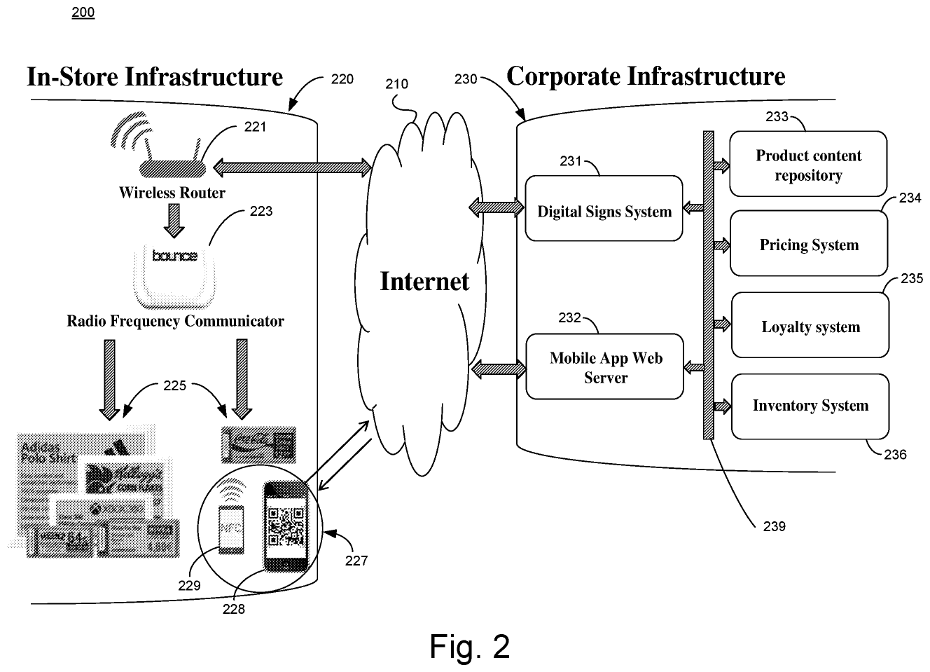

FIG. 2 shows a block diagram of an exemplary system 200 that supports a consumer shopping experience with increased consumer engagement through the use of a merchant system, a user device, and various forms of wireless identifier devices, in accordance with a representative embodiment of the present invention.

As shown in FIG. 2, the illustrated system includes a corporate infrastructure 230 and an in-store infrastructure 220, which may be interconnected via a communication network such as the Internet 210, or by any other suitable wired or wireless, public or private communication network. The in-store infrastructure 220 shown in FIG. 2 includes a wireless router 221 that is communicatively coupled to the Internet 210 by any suitable wired or wireless technology, and a radio frequency communicator 223 that communicatively couples the wireless router 221 with identifier devices represented in FIG. 2 by the digitally addressable electronic shelf labels 225, which may be distributed throughout a merchant location to display, for example, product details, inventory information, current promotional offers, and product price. In some representative embodiments of the present invention, the electronic shelf labels 225 may comprise a NFC or RFID device that identifies the product, shelf, hanger, or location within merchant location. The radio frequency communicator 223 may communicate with the electronic shelf labels 225 or other in-store infrastructure equipment, and various elements of the corporate infrastructure 230 such as, for example, the digital signs system 231, the product content repository 233, the pricing system 234, and the inventory system 236, to enable the up-to-date display of, by way of example and not limitation, product detail, promotional, inventory, and pricing information on electronic shelf labels and other forms of displays at the merchant location.

The in-store infrastructure 220 of FIG. 2 also illustrates a user device 227 that may be capable of communicating wirelessly via the Internet 210 using, by way of example and not limitation, any suitable cellular and/or wireless local area network (WLAN), wide area network (WAN), and/or metropolitan area network (MAN) known now or in the future. In addition to communication via the Internet 210, the user device 227 may comprise interface circuitry to communicate with devices such as, for example, electronic shelf labels 225, inventory tags (not shown), or other suitable identifier devices attached to various shelving, product displays, products, and signage at the merchant location, that communicate using either or both of a near-field communication (NFC) a radio frequency (RF) identification (ID) air interface protocol. Suitable interface circuitry for communication with such identifier devices may be integrated within the user device 227, or may be embodied in an interface device arranged for attachment to the user device 227, as represented by the interface device 229 for attachment to a user device 228 that lacks the ability to communicate with the various electronic shelf labels or inventory tags (not shown) attached to or a part of various shelving, product displays, products, and signage at the merchant location.

The corporate infrastructure 230 that communicates with the in-store infrastructure 220 in the example of FIG. 2 includes a digital signs system 231, a mobile application (app) web server 232, a product content repository 233, a pricing system 234, a loyalty system 235, and an inventory system 236, which are shown in FIG. 2 as being communicatively coupled to one another via a communication network 239. The digital signs system 231 may be used for managing digital signage in one or more physical locations of a business enterprise. Digital signage may include, by way of example and not limitation, various forms of graphical or textual displays such as liquid crystal displays (LCDs), light emitting diode-based (LED) displays, cathode ray tube (CRT) displays, electronic paper-based displays, video or digital projection systems, point-of-sale signage, and electronic shelf labels used in a business environment such, for example, a location of a merchant.

As noted above, the corporate infrastructure 230 of FIG. 2 also includes a mobile application (app) web server 232 that serves information such as, for example, web pages representing merchant or product information from the product content repository 233, to electronic devices such as, for example, the user device 227 and/or the electronic devices 20, 20′, 20″ described above with respect to FIG. 1.

The product content repository 233 of FIG. 2 may be used to store information about products and services available from one or more in-store locations, or other forms of product delivery and distribution of the merchant operating in-store infrastructure 220, such as orders placed via the Internet and delivered by commercial carrier or picked up by the customer from a brick-and-mortar location of the merchant.

The corporate infrastructure 230 of FIG. 2 includes a pricing system 234 for managing pricing information, promotional pricing, offers, and other information related to pricing of products and services of various physical locations of the merchant operating in-store infrastructure 220. The pricing system 234 may, for example, provide pricing information to the digital signs system 231, and may comprise rules for pricing of product based upon inventory, time of the year, competitor pricing information, percentage and dollar discount offers currently available from the merchant, and consumer membership in any of a variety of loyalty program(s) of the merchant or their business partners.

The loyalty system 235 may process and maintain membership information regarding consumers that belong to one or more loyalty programs of the merchant or its business partners, and related information for running such a program. The loyalty system 235 may be used to maintain member information including, by way of example and not limitation, member gender, name, residence address, residence telephone number(s), and email address(es); member product preferences, brand preferences, and manufacturer preferences. The member information may also include member online and in-store purchase and/or shopping history including, for example, purchase dates and times, product identifiers, store locations, website(s) and web page(s) viewed, and product return history. In addition, the member information may include information tracking the response of the member to product promotions and offers; information identifying any loyalty reward credits or “points” accumulated by the member, and information representative of member eligibility for various promotions, offers, and consumer activities such as contests, sweepstakes, and in-store games.

The corporate infrastructure 230 illustrated in FIG. 2 also includes an inventory system 236 for maintaining product inventory information for the merchant. Information identifying products by manufacturer, model, color, type size, style, serial number, associated stock keeping unit (SKU) numbers, product expiration date or “sell by” date, and other information useful in tracking units of product in stock, on order, and/or previously sold for various time periods and store locations, regions, or nations may be maintained by the inventory system 236.

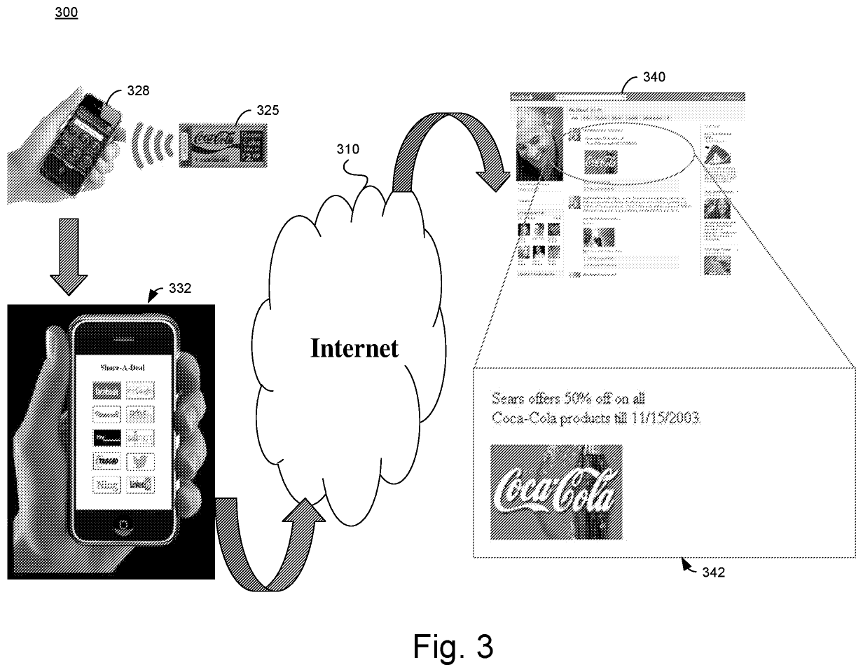

FIG. 3 illustrates exemplary social networking aspects of a system such as that shown in FIG. 2, in accordance with a representative embodiment of the present invention. In the example of FIG. 3, an NFC or RFID enabled user device 328, which may correspond to the user device 228 of FIG. 2 or the user device 20″ of FIG. 1, receives NFC, RFID, or other suitable signals from an electronic shelf label (ESL) 325 or an embedded or separate product RFID device (not shown), which may correspond to one of the electronic shelf labels 225 of FIG. 2, or an RFID device on a product item on a shelf or hanger. The signals from the electronic shelf label 325 or RFID device received by the user device 325 may be representative of or associated with product information such as, for example, one or more of a product identifier (e.g., a item number, part number, stock-keeping-unit (SKU) number, a universal product code (UPC)), the name of the product, the product brand, the product price, and/or a universal resource locator (URL)/uniform resource identifier (URI) identifying a page of a manufacturer or merchant web site for the product. Such signals may be understood by a mobile application in the user device 328, which may then, for example, display a screen 332 identifying the electronic communication mechanisms available to the user for messaging friends, family, members of a social network, or others. The user may then choose to share information captured from the ESL 325 or RFID device by selecting from icons representing the various mechanisms of electronic distribution shown on the screen 332 of the mobile application in the user device 328 including, by way of example and not limitation, the Twitter®, Pinterest®, and Facebook® social networks. The information about the product represented by the information in the signals from the ESL 325 or embedded or separate RFID device may then be shared by the user via the Internet 310 with members of his/her social network. The shared information may then appear as a post to the social network page of the user, or by posting the information to the individual social network locations for selected members of the social network of the user.

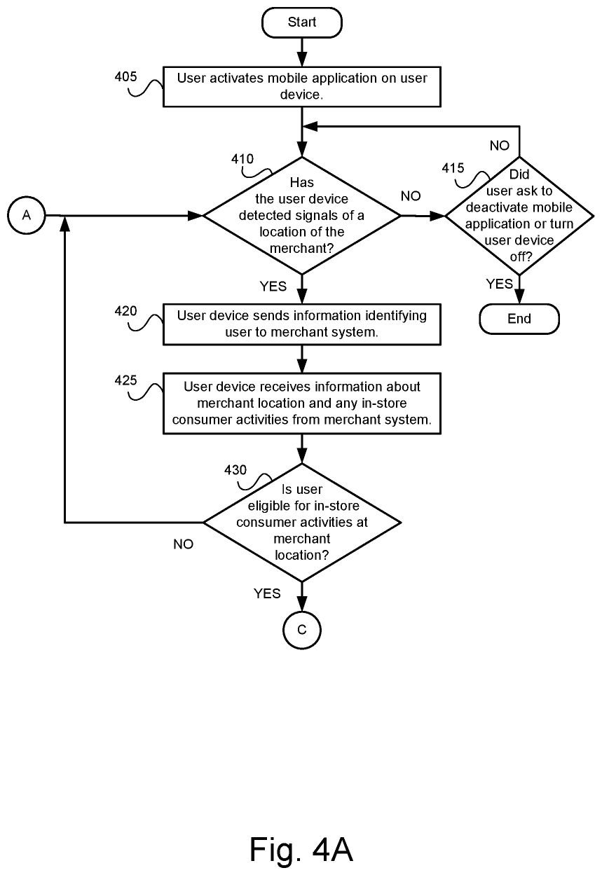

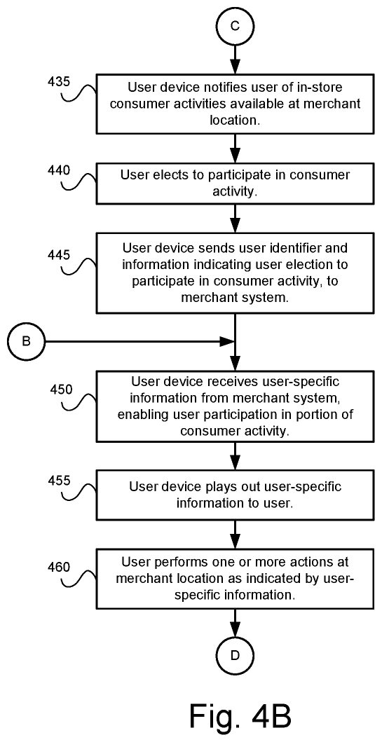

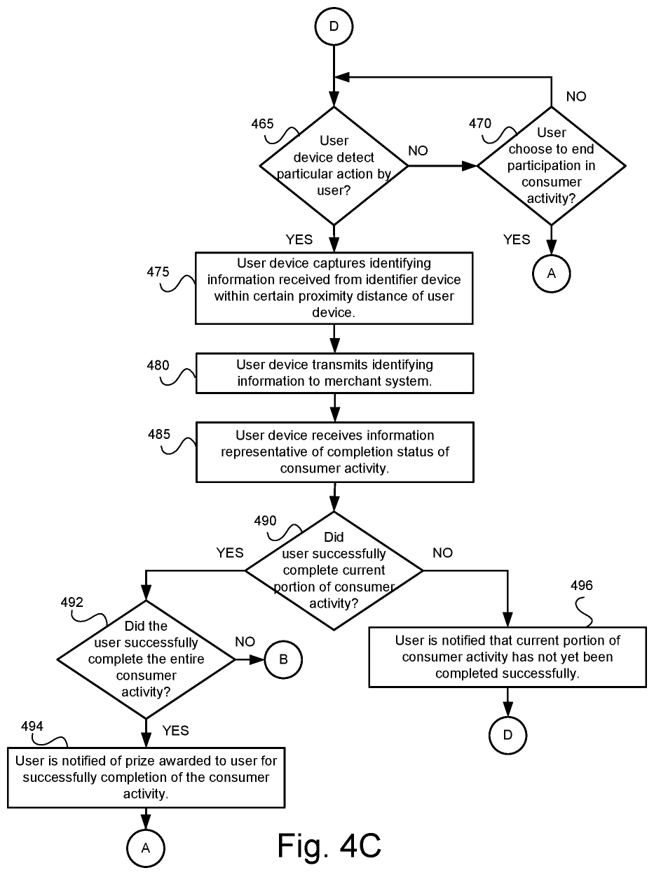

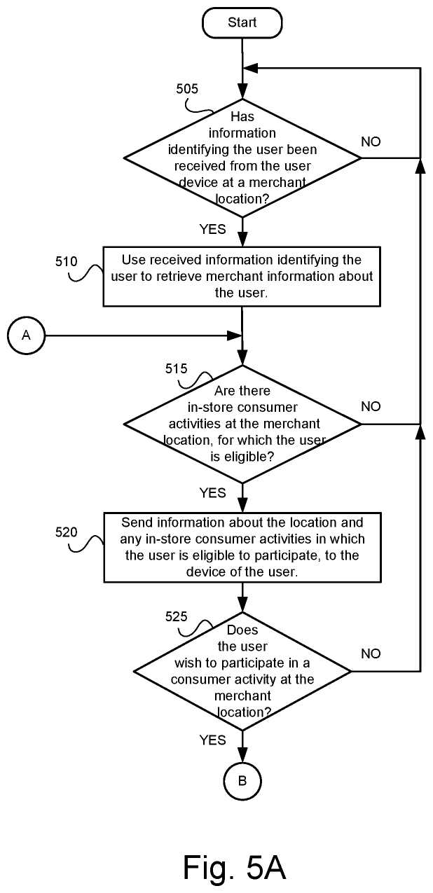

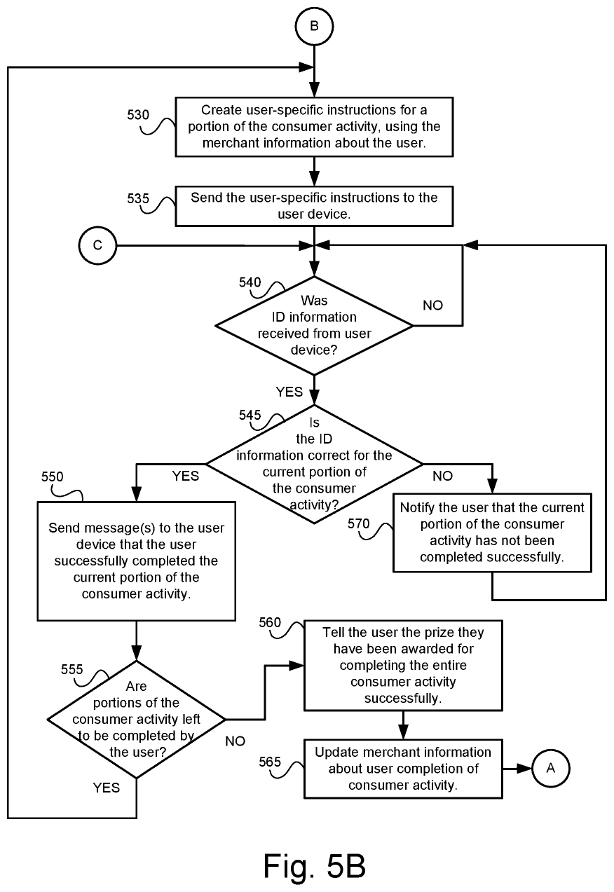

FIGS. 4A-4C illustrate a flowchart showing an exemplary method of operating a user device and various forms of wireless product identification devices in an in-store consumer activity, in accordance with a representative embodiment of the present invention. The actions illustrated in the flowchart of FIGS. 4A-4C may be performed by, for example, instructions executed by one or more processors of a user device such as the user device 20″ of FIG. 1, the user device 227 of FIG. 2, or the user device 328 of FIG. 3, for example. In performing the actions of the illustrated exemplary method, the user device may communicate with elements of the computer network 100 as described below with respect to the flowchart illustrated in FIGS. 5A-5B.

The method of operating a user device as illustrated in FIGS. 4A-4C begins at block 405, when a mobile application (app) supporting user participation in in-store consumer activities is activated by the user. Next, at block 410, the mobile app determines whether the user device is presently in, for example, a retail location of a merchant that made the mobile application available to the user. In some representative embodiments of the present invention, the mobile application may do this by detecting receipt of signals specific to the infrastructure of a location of the merchant sponsoring the mobile application. In some representative embodiments of the present invention, such signals may be, for example, specific digital information transmitted by a Wi-Fi network operated at the merchant location, for example. If signals specific to the infrastructure of a location of the merchant are detected, the method of FIG. 4A continues at block 420, described below. However, if no such specific signals are detected by the mobile application, the mobile application may then, at block 415, determine whether the user has acted to deactivate or stop the mobile application, or turn off the user device. If the user has acted to deactivate or stop the mobile application, or turn off the user device, the method of FIG. 4A-4C ends. If the user has not requested to deactivate the mobile application, or to turn the user device off, the method loops back to block 410, to again check whether signals specific to the infrastructure of a location of the merchant are detectable.

If, at block 410, the signals specific to a location of the merchant are detected, then at block 420, the mobile application in the user device sends information identifying the user to a merchant system such as, for example, the host system 68 of FIG. 1, via the infrastructure of the merchant location. The merchant system thus knows the identity and whereabouts of the user visiting a location of the merchant. The mobile application in the user device then, at block 425, receives from the merchant system via the infrastructure of the merchant location, information about the merchant location in which the information has been personalized for the user including, for example, any in-store consumer activities in which the user is eligible to participate. Next, at block 430, the mobile application determines whether any in-store consumer activities are available to the identified user, from the information about the merchant location received from the merchant system. If no in-store consumer activities are available to the user, whether it is because no in-store consumer activities are available to anyone at the merchant location, or because the identified user is ineligible to participate at the visited location of the merchant, the method of FIGS. 4A-4C returns to block 410, to repeat the actions described above. If, however, it is determined that consumer activities for which the identified user is eligible are available at the merchant location, the method progresses to block 435.

At block 435, the actions of the method cause the user device to notify the user of the in-store consumer activities available to the user at their current merchant location. Then, at block 440, the user may elect to participate in one of the in-store consumer activities available to her/him. Next, at block 445, the user device sends information identifying the user and the in-store consumer activity selected by the user, to the merchant system. For example, in one representative embodiment of the present invention, the user may be eligible for and may therefore choose to participate in a consumer game in which the user attempts to identify and locate particular products or locations within the merchant location, based upon a series of clues provided to the user by the merchant system via the mobile application. At block 450, the mobile application of the user device receives user-specific information such as, by way of illustration and not limitation, a task, action or portion of a consumer activity (e.g., instructions and a clue to solving a task), to enable the user to participate in solving one or more tasks, actions, or portions of a series of tasks, actions, or portions of the consumer activity.

Next, at 455, the user device plays the user-specific information received from the merchant system to the user. The user specific information may be in the form of text, graphics, still images and/or streaming video, and may or may not be accompanied by audio content, and may provide user-specific instructions for the completion of a task, action, or portion of the user-selected consumer activity at the merchant location. At block 460, the user performs one or more tasks, actions, or portions of the consumer activity, according to the user-specific information received from the merchant system. For example, in one representative embodiment of the present invention, the user-specific information may direct the user to locate a particular product item having certain characteristics in the appliance department of the merchant location. The information provided specifically to the user by the merchant system may, for example as part of a task, action, or portion of the consumer activity, request the user to perform a particular action such as, by way of example and not limitation, position and activate the user device in order to scan a UPC, barcode, or 2D code of a product using an image capture or optical scanning device, such as the image capture/optical scanning device 660 of FIG. 6 described below. The particular user action may also include, for example, placing the user device in an appropriate location to scan an RFID device attached to or embedded within a product or clothing item, or moving the user device in a predefined motion pattern such as, by way of example and not limitation, “bumping” or “tapping” upon an object or shaking the user device while within a certain proximity distance from a particular piece of NFC-device equipped signage, to cause capture of identifying information provided by the nearby RFID device or NFC device using an NFC/RFID interface such as the NFC/RFID interface 655 of FIG. 6, discussed further, below.

Next, the user device may, at block 465, determine whether a particular action by the user has been detected. If the particular action by the user is detected, the method of FIGS. 4A-4C moves to block 475, described below. If, however, no such particular user action with the user device is detected at block 465, then the mobile application, at block 470, may determine whether the user has indicated that he/she wishes to end participation in the consumer activity via user input on the user device (e.g., via user input device 630 of FIG. 6). If the user does wish to end the consumer activity at this point, the method of FIGS. 4A-4C returns to block 410, described above.

At block 475, the method of FIGS. 4A-4C captures identifying information from the UPC, barcode, 2D code, RFID device, and/or NFC device within a certain operating proximity distance of the user device. The mobile application of the user device then, at block 480, transmits the captured identifying information to the merchant system, via the in-store infrastructure and the Internet or other suitable wired or wireless communication network, signaling completion of the present task, action, or portion of the consumer activity. Next, at block 485, the user device receives information from the merchant system, indicating the status of the completion of the current task, action, or portion of the consumer activity as determined by the merchant system from, among other things, the identifying information sent to the merchant system by the mobile application of the user device. The mobile application then, at block 490, determines from the status information sent by the merchant system, whether the user has successfully completed the current task, action, or portion of the consumer activity. If, at block 490, it is determined that the user has successfully completed the current task, action, or portion of the consumer activity, the method moves to block 492, where a check is made to determine whether the user has completed the entire consumer activity successfully. If the user has not completed the entire consumer activity successfully, the method of FIGS. 4A-4C continues at block 450, described above. If, however, the user has completed the entire consumer activity successfully, the method moves to block 494, and the user is notified of the prize that they have been awarded for successfully completing the consumer activity. The method of FIGS. 4A-4C then continues at block 410, described above.

If, at block 490, it is determined that the user did not successfully complete the current task, action, or portion of the consumer activity, the method moves to block 496, where the user is notified that the current task, action, or portion of the consumer activity has not been successfully completed. The method of FIGS. 4A-4C them continues at block 465, to permit the user to attempt to successfully complete the current task, action, or portion of the consumer activity.

FIGS. 5A-5B illustrate a flowchart showing an exemplary method of operating a system that supports in-store consumer activities using a user device such as, for example, the host system 68 of FIG. 1 communicating with a mobile application in a user device that may correspond to, for example, the user device 20″ of FIG. 1 of user device 600 of FIG. 6, wherein the mobile application operates as described with respect to the method of FIGS. 4A-4C, in accordance with a representative embodiment of the present invention. The following description of the method of FIGS. 5A-5B makes reference to the elements of the computer network of FIG. 1 and the user device 600 of FIG. 6. The method of FIGS. 5A-5B begins at block 505, following startup of a computer system such as the host system 68 of FIG. 1, that may be operated by or for a merchant to, for example, support, in addition to other merchant needs, the in-store consumer activities of consumers at locations of the merchant.

At block 505, the method of FIGS. 5A-5B determines whether information identifying a user has been received by a merchant system from a user device at a business location of the merchant. If no user identifying information is received by the merchant system, the method of FIGS. 5A-5B then, at block 505, repeats the determination. If, however, identifying information for a user is received from a user device at the merchant location, the method then moves to block 510, where the merchant system uses the information identifying the user to retrieve personal information about the user maintained by the merchant. Next, at block 515, the method determines whether there are any in-store consumer activities in which the user is eligible to participate, using the retrieved personal information for the user. If there are no in-store consumer activities in which the user is eligible to participate, the method transitions to block 505, described above. If, however, it is determined at block 515 that there are in-store consumer activities in which the user is eligible, the method moves to block 520, where the merchant system sends to the user, information about the merchant location and in-store activities for which the user is eligible to participate. Then, at block 525, the method determines whether the user has sent any indication that the user wishes to participate in an in-store consumer activity at the merchant location. If the user does not wish to participate in any of the consumer activities for which the user is eligible, the method returns to block 505, described above. If, however, the user does indicate selection of an in-store consumer activity for which they are eligible, the method continues at block 530, where the merchant system may create user-specific instruction information for a task, action, or portion of the consumer activity using, for example, the personal information for the user and information for the merchant location. The method of FIGS. 5A-5B then causes the merchant system to send the user-specific instruction information to the user device for display or playback to the user, and the method moves on to block 540.

At block 540, the method determines whether information from an identifier device (e.g., a UPC, bar code, 2D code, RFID device, NFC device) was received from the user device. If not, the method of FIGS. 5A-5B loops back to block 540, to check once again. If, however, identifying information from an identifier device was received from the user device, the method continues at block 545, where a determination is made as to whether the identifying information for the identifier device is correct for successful completion of the current task, action, or portion of the in-store consumer activity of the user. If the received identifying information for the identifier device is not correct for the current task, action, or portion of the consumer activity, the method notifies the user, at block 570, that the current task, action, or portion of the consumer activity has not been successfully completed, and the method continues at block 540, described above.

If, however, the received identifying information for the identifier device is correct for the current task, action, or portion of the consumer activity, at block 550, the method notifies the user that the user has successfully completed the task, action, or portion of the consumer activity. The method then, at block 555, determines whether any tasks, actions, or portions of the consumer activity are left to be completed by the user. If there is at least one task, action, or portion of the consumer activity that has not yet been completed by the user, the method of FIGS. 5A-5B continues at block 530, described above. If, however, at block 555, it is determined that all tasks, actions, or portions of the consumer activity selected by the user, the method then, at block 560, informs the user that they have successfully completed all of the consumer activity and tells the user of the award that they will receive for completing the consumer activity successfully. The method then, a block 565, updates the personal information of the user maintained by the merchant, to reflect successful completion of the consumer activity by the user, and the method continues at block 515.

FIG. 6 is a block diagram illustrating a personal electronic device 600 that may correspond to, for example, the electronic devices 20′, 20′, 20″ shown in FIG. 1, in accordance with a representative embodiment of the present invention. The personal electronic device 600 may correspond to electronic user devices such as, by way of example and not limitation, a smart phone, a tablet computer, a cellular phone, a media player, a handheld personal computer, a laptop, a notebook computer, a net book computer, a desktop computer, a television, or any other suitable electronic device having the functionality discussed herein.

As shown in FIG. 6, the personal electronic device 600 includes a processor 610, an RF transceiver A 602, an RF transceiver B 603, a wired interface 604, a display device 620, a user input device 630, an audio interface 640, one or more accelerometers, gyroscopes, or compasses 645, a memory 650, near field communication (NFC)/radio frequency identification (RFID) interface 655, and an image capture/optical scanning device 660. The processor 610 may be, for example, a suitable microprocessor or microcomputer having sufficient computing power to control the personal electronic device 600, and is operably coupled to the RF transceiver A 602, the RF transceiver B 603, and the wired interface 604. The RF transceiver A 602 and RF transceiver B 603 may comprise any necessary circuitry, logic, and software/firmware for wireless communication using any of, for example, the cellular, Bluetooth, Wi-Fi (e.g., IEEE 802.11 a/b/g/n/ac), Zigbee, WiMAX, Near Field Communication (NFC), radio frequency identifier (RFID), or any other wireless network air interface standard known now or in the future. The wired interface 604 may comprise any necessary circuitry, logic, and software/firmware for wired communication over any of, for example, an Ethernet, Universal Serial Bus, FireWire (IEEE 1394) or other wired networks known now or in the future.

The processor 610 is also operably coupled to the memory 650, which may be used for non-transitory storage of executable program instructions, parameters, and data for management and control of any of the circuitry of the personal electronic device 600. The processor 610 is also operably coupled to the display device 620, which may comprise, for example, one or more LED, OLED, LCD, or other suitable form of visual display capable of presenting text and/or graphics, and may comprise any circuitry, logic, or software/firmware to support, for example, a graphical user interface (GUI). The processor 610 is operably coupled to the user input device 630, which may comprise, for example, suitable switches, buttons, or touch sensitive surfaces to enable user control and operation of the personal electronic device 600, and may comprise any necessary circuitry, logic, and software/firmware to allow the user input device 630 to perform those functions. In a representative embodiment of the present invention, the user input device 630 may, for example, be include a touch sensitive surface at the viewing side of the display device 620, enabling a user to use the touch sensitive surface of the display device to enter user inputs and respond to information displayed on the display device 620.

The processor 610 is also operably coupled to the audio interface 640, which comprises any necessary circuitry, logic, and software to interface a microphone 605 and a speaker 606 to the processor 610. In some representative embodiments of the present invention, the processor 610 may be operably coupled to a NFC/RFID interface 655 that may be used to communicate with, by way of example and not limitation, NFC/RFID-enabled electronic shelf labels (ESLs), credit and identification cards and badges, tags, keychain fobs, and any other devices having NFC and/or RFID communication capability. In addition, the processor 610 is operably coupled to an image capture/optical scanning device 660 that may include, by way of example and not limitation, a monochrome or color digital imaging device, a digital camera, an infrared receiver, and/or a scanner capable of detecting light signals representative of bar codes (e.g., UPC), two-dimensional codes (e.g., a QR code), images, or other forms of optical information known now or in the future.

Aspects of the present invention may be seen in a method of operating a system supporting user engagement in consumer activities at one or more locations of a merchant. Such a method may comprise retrieving information for a merchant location using information identifying the merchant location received from the merchant location, and retrieving personal information for a user, using user identity information received from a device of the user via the merchant location, and determining whether the user is eligible to participate in any consumer activities at the merchant location, using the retrieved information for the user and the merchant location. A method according to a representative embodiment of the present invention may also comprise receiving, from the user device, an indication of user selection of a consumer activity for which the user is eligible to participate, sending to the user device, instructional information for the user, to enable user completion of a portion of the consumer activity, and receiving from the user device, information representative of a particular user action signifying completion by the user of the portion of the consumer activity. The method may further comprise, in response to receipt of the information representative of a user action signifying completion of a portion of the consumer activity, determining whether the user has successfully completed all portions of the consumer activity, and notifying the user of an award for successful completion of the consumer activity, if the user has successfully completed at least one required portion of the consumer activity.

In a representative embodiment of the present invention, the consumer activity may comprise an in-store game played by the user at the merchant location, and user eligibility to participate ma be determined using the personal information of the user. The instructional information may be determined using one or more user behaviors known to the merchant, and the one or more user behaviors may comprise one or both of a purchase history of the user and a shopping history of the user. The method may comprise notifying the user of any consumer activities at the merchant location for which the user is eligible to participate, via the user device. The personal information may comprise one or both of purchase history information and product preference information, and the personal information of the user may comprise information about a member of a social network of the user. Notifying the user of the award may comprise notifying one or more members of the social network of the user of the award, and the particular action may comprise one or more of optically scanning an image, placing the user device within a certain proximity distance of a wireless identifier device, and/or moving the user device according to a predefined motion pattern.

Additional aspects of the present invention may be found in a system supporting user engagement in consumer activities at one or more locations of a merchant, where the system comprises at least one processor for communicatively coupling to a user device and data storage for holding personal information of the user, and wherein the at least one processor, during operation, may at least perform the method described above.

Yet other aspects of the present invention may be observed in a non-transitory computer-readable medium having a plurality of code sections, where each code section comprises a plurality of instructions executable by one or more processors to perform actions of the method described above.

Although devices, methods, and systems according to the present invention may have been described in connection with a preferred embodiment, it is not intended to be limited to the specific form set forth herein, but on the contrary, it is intended to cover such alternative, modifications, and equivalents, as can be reasonably included within the scope of the invention as defined by this disclosure and appended diagrams.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1-30. (canceled)

31. A system, comprising:
at a first location:
a product content repository configured to store information about products and services that are found at one or more second locations that are different than the first location;
a digital signs system configured to manage digital signage, at the one or more second locations, corresponding to the products and services;
a pricing system configured to provide pricing information to the digital signs system; and
a mobile application (app) web server configured to serve the information about products and services, from the product content repository, to a plurality of user devices at the one or more second locations.

32. The system of claim 31, wherein:
the one or more second locations comprise one or more physical locations of a business enterprise.

33. The system of claim 31, wherein:
the digital signage comprises one or more:
graphical displays,
textual displays,
liquid crystal displays (LCDs),
light emitting diode (LED) displays,
cathode ray tube (CRT) displays,
electronic paper-based displays,
video projection systems,
digital projection systems
point-of-sale signage, and
electronic shelf labels (ESLs).

34. The system of claim 31, wherein:
the system comprises, at the first location, an inventory system configured to maintain product inventory information for a merchant.

35. The system of claim 31, wherein:
the system comprises, at the first location, a loyalty system configured to process and maintain membership information regarding consumers that belong to one or more loyalty programs of a merchant.

36. The system of claim 31, wherein:
each of the plurality of user devices is configured to run, via at least one processor that executes a plurality of code sections found in a non-transitory computer-readable medium, a mobile app associated with the information about products and services.

37. The system of claim 36, wherein:
the mobile app is operable for receiving, via a graphical user interface (GUI) of a user device, a selection of a consumer activity for which a user is eligible to participate.

38. The system of claim 36, wherein:
the mobile app is operable for receiving, via the mobile app web server, instructional information regarding a consumer activity.

39. The system of claim 38, wherein:
going to a particular location, finding one or both of a product or a service being offered for sale, and performing a particular action are part of the consumer activity.

40. The system of claim 36, wherein:
the mobile app is operable for guiding a user to a particular location where one or both of a product and the a is being offered for sale.

41. The system of claim 36, wherein:
the mobile app is operable for using a near-field-communication (NFC) transceiver to capture information, from one or more instances of the digital signage, about one or both of a product and a service.

42. The system of claim 36, wherein:
the mobile app is operable for determining that the user device is moving in a predefined motion pattern that corresponds to a particular action.

43. The system of claim 36, wherein:
the mobile app is operable for automatically transmitting information representative of a completion of a consumer activity to the mobile app web server.

44. The system of claim 36, wherein:
the mobile app is operable for posting, via a selection of the one or more graphical elements of a graphical user interface, captured information about one or both of a product or a service sold by a merchant.

45. The system of claim 36, wherein:
the mobile app is operable for notifying a user of an award for successful completion of a consumer activity, if the user has successfully completed at least one required portion of the consumer activity

46. The system of claim 45, wherein:
notifying the user of the award comprises notifying one or more members of a social network of the user of the award.

47. The system of claim 36, wherein:
one or more instances of the digital signage comprises an electronic tag associated with a product or a service.
